(19) United States
(12) Patent Application Publication
(10) Pub. No.: US 2008/0143678 A1
(43) Pub. Date: Jun. 19, 2008

(54) Apparatus for storing a wearable display and a keyboard

(76) Inventor: Daniel J. Sadler, Gilbert, AZ (US)

Correspondence Address: INGRASSIA FISHER & LORENZ, P.C. (MOT), 7010 E. Cochise Road, SCOTTSDALE, AZ, 85253, US

(21) Appl. No.: 11/641,129

(22) Filed: Dec. 19, 2006

(51) Int. Cl. G06F 3/02

(52) U.S. Cl. 345/168

(57) ABSTRACT

An apparatus (300) is provided for storing, when not in use, an input device (314) and a wearable display (100) that displays text provided by an RF communication device (200). The apparatus (300) comprises a soft flexible material (302) including a main portion (304) having a soft keyboard including keys (313) as an integral part thereof, the keyboard capable of providing the text to the RF communication device (200). A plurality of flaps (306, 308, 310, 312) integrally attached to the main portion (304) may be positioned around the wearable display (100) placed on the main portion (304).

### FIELD OF THE INVENTION

The present invention generally relates to a wearable display/keyboard computer system, and more particularly to an apparatus for storing the wearable display and keyboard when not in use.

### BACKGROUND OF THE INVENTION

The computing power of cellular phones increases as technology advances, allowing for more advanced applications which may require extensive text entry. Despite the increased computing power, phone displays and keypads will likely remain small in accordance with typical user preferences for cell phone size, thus limiting text entry applications to short messages.

However, interfacing a cell phone with wearable displays, e.g., a heads up display, and a traditional QWERTY keyboard would allow users to create reports, send lengthy emails, etc. This interfaced system would give the user freedom from having to carry a heavier, more bulky computer.

However, this combination of electronic devices (cell phone, heads-up display, and QWERTY keyboard) would require the user to carry multiple items, which would be cumbersome.

There are many known publications or patents that describe hard keyboards that fold or cover electronic devices. For example, WIPO publication 2000010878 discloses a hard, wired keyboard for a PDA device that closes. U.S. Pat. No. 6,480,377 discloses a hard, integratively connected PDA/keyboard that closes. U.S. Pat. No. 5,548,477 discloses an attachable, wired, hard keyboard that folds over a PDA. U.S. Patent publication number 2003/0099086 discloses a foldable, hard keyboard (not a case). Furthermore, U.S. Pat. No. 5,295,089 discloses a foldable case for consumer electronics products. However, none of these known documents disclose a method and apparatus for storing heads-up eyewear and keyboard when not in use.

Accordingly, it is desirable to provide an apparatus for storing a wearable display and a keyboard when not in use. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

An apparatus is provided for storing, when not in use, a keyboard and a wearable display that displays text provided by an RF communication device. The apparatus comprises a soft flexible material including a main portion having a soft keyboard as an integral part thereof, the keyboard capable of providing the text to the RF communication device. For storage, a plurality of flaps integrally attached to the main portion may be positioned around the wearable display situated on the main portion.

### BRIEF DESCRIPTION OF THE DRAWINGS

The present invention will hereinafter be described in conjunction with the following drawing figures, wherein like numerals denote like elements, and

FIG. 1 is a perspective view of a wearable display in accordance with a first exemplary embodiment;

FIG. 2 is block diagram of the wearable display of FIG. 1;

FIG. 3 is a block diagram of an RF communication device in accordance with the first embodiment;

FIG. 4 is a front view of the soft material including a keyboard;

FIG. 5 is a back view of the soft material of FIG. 4;

FIG. 6 is a perspective view of the soft material of FIG. 4 in a partially closed position around the wearable display of FIG. 1; and

FIG. 7 is a perspective view of back side of the soft material of FIG. 4 in a closed position and protectively covering the wearable display of FIG. 1.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

A soft foldable keyboard which transforms into a carrying case for a wearable display is used as a text entry device for a mobile device, e.g., a cellular telephone. The keyboard may be used, for example, to type text messages such as email or business reports. The mobile phone would provide the necessary software, e.g., Microsoft Word®, and computing power. The user would view the text wearing a wearable display, e.g., a binocular display, which would provide a large private viewing area for display of the text. The preferred connection between the devices, including the keyboard, mobile communication device, and wearable display, is wireless; however, a wired connection is also envisioned. The wireless connection could be any known wireless protocol such as Bluetooth. When not in use, the keypad can be folded into a case for storage of the wearable display.

Wireless keyboards and wearable displays can solve the issues of inconvenient text entry and small displays associated with cell phones; however, they create an additional problem in that the user would need to carry multiple items, e.g., a phone, keyboard, and wearable display. The method and apparatus of the exemplary embodiment described herein solves this problem by conveniently storing both accessories (keyboard and eyewear display) in a case, or container, which is an integral part of the keyboard. This solution limits the number of items which need to be carried along with the phone by providing a compact accessory storage method and apparatus while also providing maximum text entry functionality.

A heads-up display may include a binocular display such as glasses wherein a virtual image is presented to each eye. The image, usually created by a microdisplay, for example an LCD screen, may be presented to the eye by means of refractive or reflective optics, for example, through a lens system. Ideally the virtual images presented to each eye are perfectly aligned and the user perceives a single image similar to their perception of real images.

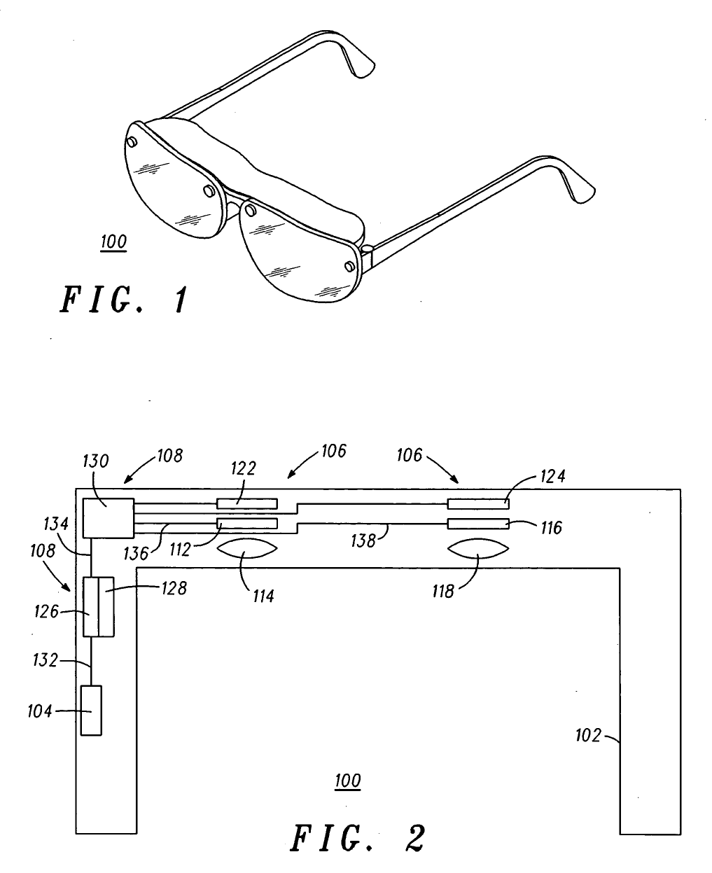

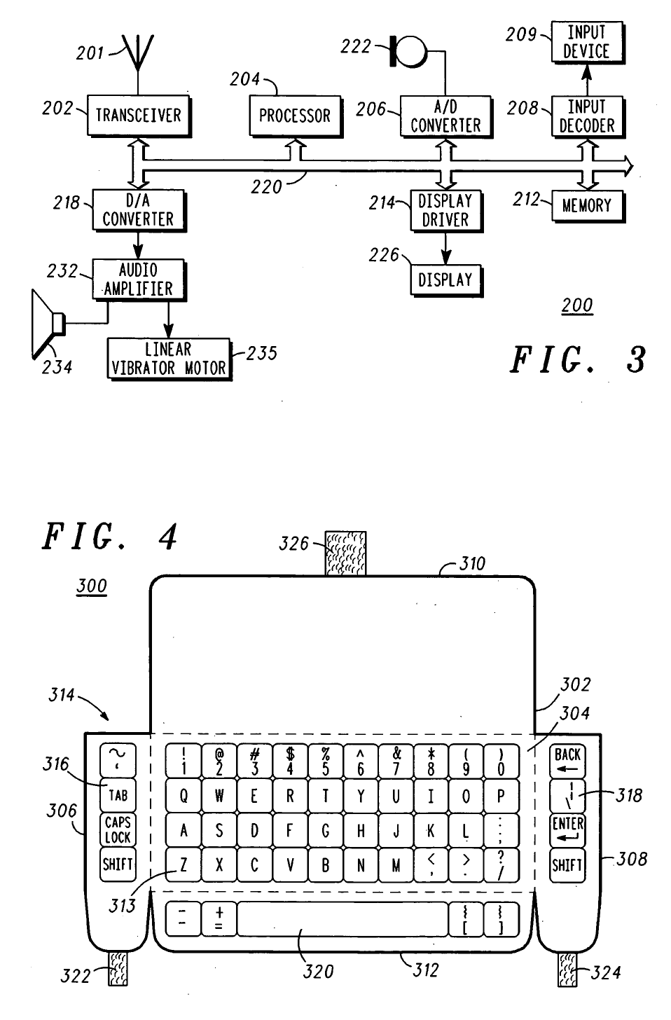

FIG. 1 is a representative view of a wearable display 100 in the form of glasses. It should be understood the present invention should not be limited by the type of wearable display 100 described herein, and may include, for example, a heads-up display and binocular eyewear. FIG. 2 is a schematic view of an exemplary embodiment of one possible wearable display of FIG. 1, a binocular display including a housing 102 comprising an image receiving device 104, optics system 106, and display modification system 108. The image receiving device 104 may, for example, comprise an input (not shown) for wired or wireless coupling or an electronic device for receiving and reading text from a cell phone. The optics system 106 includes a first microdisplay 112 and a first lens 114 for displaying the image to one eye and a second microdisplay 116 and a second lens 118 for displaying the image to the other eye. The optical system 106 may also include backlights 122 and 124 for lighting the microdisplays 112 and 116. It should be understood that there are many types of optical systems that may include, for example, mirrors and/or waveguides. The display modification system 108 includes a microcomputer 126 and memory 128 coupled to the image receiving device 104, and a display driver 130 coupled between the microcomputer 126 and the microdisplays 112 and 116. The microcomputer 126 and/or the memory 128 may be integrated into the binocular display device 100 or may reside in the cell phone and be coupled electronically to the heads-up display 100.

When an image, which typically would comprise a page of text, is received by the image receiving device 104, it is transmitted to the microcomputer 126 via first connector 132. The image is then transmitted to the display driver 130 via second connector 134, and to first and second microdrivers 112 and 116 via third connector 136 and fourth connector 138, respectively, for viewing.

FIG. 3 is a block diagram of a cell phone in accordance with the exemplary embodiment, though any type of mobile communication device is envisioned as an embodiment. The cellular telephone 200 comprises a transceiver 202, a processor 204, an analog to digital converter (A/D) 206, a input decoder 208, a memory 212, a display driver 214, a digital to analog converter (D/A) 218 coupled together through a digital signal bus 220. The transceiver module 202 is coupled to an antenna 201. Carrier signals that are modulated by data, e.g., digitally encoded voice audio, pass between the antenna 201, and the transceiver 202.

A microphone 222 is coupled to the A/D 206. Audio, including spoken words, is input through the microphone 222 and converted to a stream of digital samples by the A/D 206. The input device 209 is coupled to the input decoder 208. The input decoder 208 serves to identify depressed keys, for example, and provide information identifying each depressed key to the processor 204. The display driver 214 is coupled to a display 226.

The D/A 218 is coupled through an audio amplifier 232 to a speaker 234 and, optionally, a vibratory motor 235. The D/A 218 converts decoded digital audio to analog signals and drives the speaker 234 and vibratory motor 235. The audio amplifier 232 may comprise a plurality of amplifiers with each driving a separate speaker/vibratory motor combination.

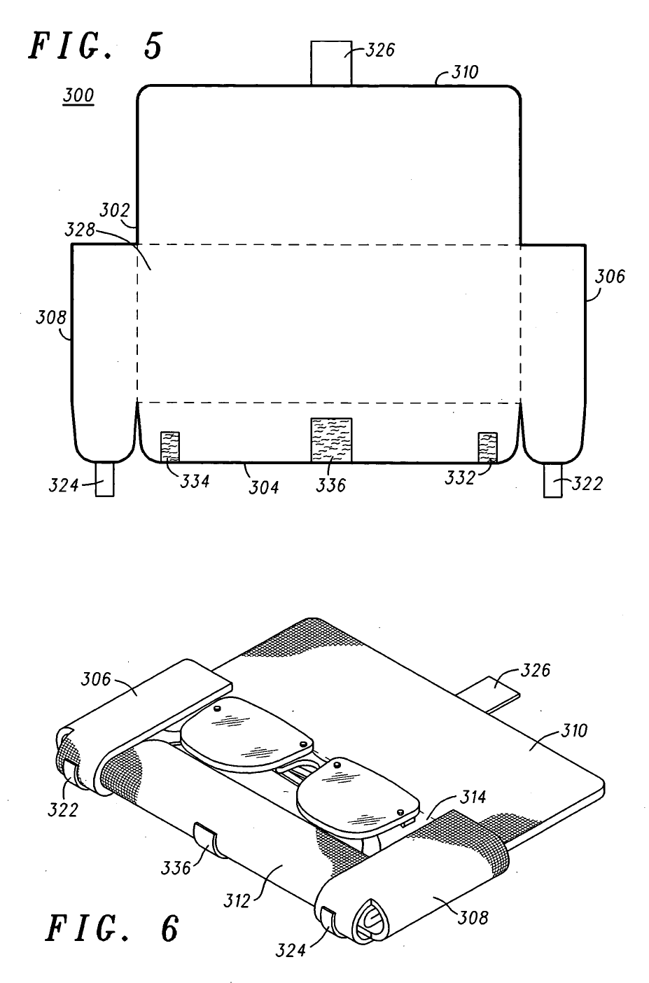

FIGS. 4 and 5 are a front and back view of an input device 300 including a soft material 302 containing a keyboard 314 in accordance with the exemplary embodiment. The input device 300, comprises the soft material 302 including a main portion 304, side flaps 306, 308, a main flap 310 and a bottom flap 312. The keyboard 314 includes “keys” 313, preferably a QWERTY keyboard, located on the front side of the main portion 304, keys 316 located on the front side of the side flap 306, keys 318 located on the front side of the side flap 308, and keys 320 located on the front side of the bottom flap 312. The keys 313, 316, 318, 320 are actually pressure points.

The technology for the keys and the soft material may comprise, for example, the material technology developed by Peratech LTD, of Great Britain, known as Quantum Tunneling Composites (QTC). QTC's rely on quantum tunneling of metallic particles in metal-filled polymers, and as pressure is applied to the QTC, the metallic particles get close enough to each other that quantum tunneling occurs, causing a transformation from insulator to conductor in which the resistance drops exponentially. This technology is described in World Intellectual Property Organization publications WO9833193, WO9938173, and WO0079546 assigned to Peratech, LTD.

Referring again to FIGS. 4 and 5, the side flaps 306, 308 and the main flap 310 each have a tab 322, 324, and 326, respectively. The back side 328 of the main portion 304 contains material 332, 334, 336 for attachably receiving the tabs 322, 324, and 326, respectively. The respective tabs provide an attraction that can be broken by pressure applied by the user. Velcro® is an example of the material that may be used for the tabs.

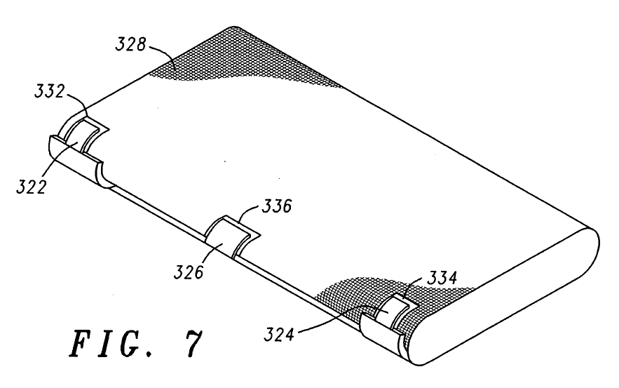

When the keyboard 300 is being used, the flaps 306, 308, 310, 312 are extended as shown in FIG. 4. When not in use, the heads-up display 100 may be placed on the keyboard 314 of the main portion 304. The bottom flap 312 and side flaps 306, 308 are folded up as shown in FIG. 6. The tab 322 is mated with the material 332 and tab 324 is mated with material 334. The main flap 310 is then pulled down (FIG. 7) over the heads-up display 100 and tab 326 is mated with material 336 to enclose the heads-up display 100 within the soft material 302.

In summary, a soft, foldable keyboard and a wearable heads-up display electronically integrated with a mobile communication device overcome problems of inconvenient text entry and small displays associated with cell phones. When not in use, the keyboard may be folded to provide a soft case for the heads-up display. The cell phone optionally may be stored in a pouch in the soft keyboard. This method of storage prevents the user from having to carry multiple devices.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

1. An apparatus for storing a wearable display that displays text provided by a mobile communication device, comprising:
a first soft keyboard capable of providing the text to the RF communication device; and
a soft flexible material attached to the first soft keyboard, wherein the first soft keyboard and the soft flexible material may be positioned around the wearable display when not in use.

2. The apparatus of claim 1 wherein the soft flexible material comprises a second soft keyboard.

3. The apparatus of claim 1 wherein the soft flexible material comprises a plurality of flaps.

4. The apparatus of claim 1 wherein the wearable display, mobile communication device, and the first soft keyboard communicate via wires.

5. The apparatus of claim 1 wherein the wearable display, mobile communication device, and the first soft keyboard communicate wirelessly.

6. The apparatus of claim 1 wherein the first soft keyboard comprises four sides and the soft flexible material comprises four flaps, one on each of the four sides.

7. The apparatus of claim 1 wherein the soft flexible material comprises a first attachment device and the first soft keyboard comprises a second attachment device for coupling to the first attachment device.

8. An apparatus for storing a wearable display that displays text provided by a mobile communication device, comprising:
a soft flexible material comprising:
a main portion comprising a front and a back;
a first flap integrally attached to a first side of the main portion;
a second flap integrally attached to a second side of the main portion;
a main flap integrally attached to a third side of the main portion;
a soft keyboard integrated within the front of the main portion, the keyboard capable of providing the text to the mobile phone;
a first attachment apparatus positioned on the first flap;
a second attachment apparatus positioned on the second flap; and
a third attachment apparatus positioned on the main flap, wherein the soft flexible material may be positioned to encase the wearable display by attaching the first, second, and third attachment apparatuses to the first portion.

9. The apparatus of claim 8 wherein at least one of the first, second, and third flap comprises another soft keyboard.

10. The apparatus of claim 8 wherein the wearable display, mobile communication device, and the soft keyboard communicate via wires.

11. The apparatus of claim 8 wherein the wearable display, mobile communication device, and the first keyboard communicate wirelessly.

12. The apparatus of claim 8 further comprising a fourth attachment apparatus positioned on the main flap for coupling to the first attachment device.

13. The apparatus of claim 8 further comprising fourth, fifth, and sixth attachment apparatus positioned on the main flap for coupling, respectively, to the first, second, and third attachment apparatus.

14. An apparatus comprising:
a mobile communication device;
a wearable display communicating with the mobile communication device for displaying text; and
a soft keyboard communicating with the mobile communication device for providing the text thereto, wherein the soft keyboard may be folded to store the wearable display when not in use.

15. The apparatus of claim 14 wherein the soft keyboard further comprises:
a first portion including the soft keyboard as an integral part thereof, the soft keyboard for providing the text to the RF communication device; and
a second portion integratively attached to the first portion wherein the first and second portion may be folded around the wearable display when not in use.

16. The apparatus of claim 14 wherein the second portion comprises another soft keyboard.

17. The apparatus of claim 14 wherein the second portion comprises a plurality of flaps and the wearable display comprises eye wear.

18. The apparatus of claim 14 wherein the wearable display, mobile communication device, and the first keyboard communicate via wires.

19. The apparatus of claim 14 wherein the wearable display, mobile communication device, and the first keyboard communicate wirelessly.

20. The apparatus of claim 14 wherein the second portion comprises a first attachment device and the first portion comprises a second attachment device for coupling to the first attachment device.
